(19) United States
(12) Patent Application Publication
(10) Pub. No.: US 2005/0200914 A1
(43) Pub. Date: Sep. 15, 2005

(54) Digital camera and image recording method

(75) Inventors: Kenji Ito, Saitama-ken (JP); Kenji Funamoto, Saitama-ken (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/072,240

(22) Filed: Mar. 7, 2005

(30) Foreign Application Priority Data
Mar. 12, 2004 (JP) 2004-71530

(51) Int. Cl. H04N 1/40

(52) U.S. Cl. 358/471

(57) ABSTRACT

A digital camera performs first predetermined image processing on digital image data representing a rectangular primary area in an object image acquired through photographing, and performs second predetermined image processing on digital image data representing secondary areas other than the primary area of the object image. The second image processing has an effect such that a compression rate for the secondary areas becomes higher than a compression rate for the primary area in the digital image data when the digital image data is compressed. After the digital image data subjected to these image processings has been compressed, the digital image data is recorded in a recording medium. In this manner, a data amount of the digital image data recorded through photographing can be effectively reduced.

### CROSS-REFERENCE TO RELATED APPLICATION

This application claims priority under 35 USC 119 from Japanese Patent Application No. 2004-71530, the disclosure of which is incorporated by reference herein.

### BACKGROUND OF THE INVENTION

1. Field of the Invention

The present invention relates to a digital camera, and particularly to a digital camera and an image recording method, wherein digital image data acquired through photographing is compressed before being recorded.

2. Description of the Related Art

In recent years, the speed of digital camera popularization has been remarkable, and the volume of shipments per year thereof has almost surpassed that of film cameras.

In conventional digital cameras, aspect ratios of images (object images) acquired by image pickup devices, such as CCD and CMOS image sensors, are usually set to 4:3. This is to accommodate the 4:3 aspect ratio of display areas of conventional display devices, such as television receiving sets and liquid crystal displays acting as monitors for object images of digital cameras.

On the other hand, television receiving sets having display areas with an aspect ratio of 16:9 (so-called “wide size”) are recently spreading. Similarly, with respect to object images recorded through photographing by digital cameras, there are demands for digital cameras that can record object images, which have been photographed by using image pickup devices having an aspect ratio of 4:3, also at an aspect ratio of 16:9.

The numbers of pixels of recent image pickup devices are rapidly increasing, and the amount of digital image data corresponding to one object image is becoming huge. Therefore, in order to record digital image data acquired through photographing by a digital camera, it is becoming essential to compress the digital image data.

With these background facts, there are conventional techniques aimed at efficiently compressing image data in a case where digital image data representing an image having a certain aspect ratio is converted into digital image data representing an image having another aspect ratio. For example, such a technique has been proposed, wherein an object is photographed to obtain standard image data representing an object image. Then, for at least one of upper and lower portions of the standard image, a level for data compression of the image data within a range of a total block length (in a vertical direction) of N unit blocks (N is an integer) is fixed at a constant level, and the remaining portion of the standard image, represented by the standard image data corresponding to a wide-size display image, is left unchanged at this stage. Subsequently, for the image data fixed at the constant level and the image data representing the remaining portion of the standard image as the wide-size display image, data compression is performed for each unit block so that a data amount for one entire image is reduced to a predetermined data amount. Then, the compressed image data is recorded, for example, in a recording medium (see, for example, Japanese Patent Application Laid-Open (JP-A) No. 8-294090).

According to this technique, the portion of the fixed-level image data can be compressed at a high compression rate, and this allows low-rate compression of the effective image portion. Therefore, a high quality image can be obtained.

In the above-described conventional technique, only the portion of the digital image data corresponding to the wide-size display image area is utilized. However, it is also conceivable to utilize effectively the digital image data recorded corresponding to areas other than the wide display area. As an example of effective utilization, there is such a case where a desired portion of an object is incomplete, at at least one of upper and lower end portions, of an object image having the aspect ratio of 16:9 acquired through photographing, and the incomplete portion is then recovered by using the image data corresponding to areas other than the wide display area.

However, in this case, it is necessary to record all of the digital image data acquired by the image pickup device. Therefore, a required memory capacity for recording the digital image data is significantly increased, comparing with a case where recording only digital image data corresponding to the partial area of the entire image having the aspect ratio of 16:9, including the above-described conventional technique, and this is problematic.

### SUMMARY OF THE INVENTION

The present invention has been made in view of the above circumstances, and provides a digital camera and an image recording method, which allow effective reduction of an amount of digital image data acquired through photographing to be recorded.

A first aspect of the invention is a digital camera including: an image pickup section for acquiring digital image data representing an object image through photographing; an image processing section for performing a first predetermined image processing on digital image data representing a rectangular primary area in the object image, and performing a second predetermined image processing on digital image data representing secondary areas other than the primary area in the object image, the second image processing having such an effect that a compression rate for the secondary areas becomes higher than a compression rate for the primary area in the digital image data when the digital image data is compressed; a compressing section for compressing the digital image data processed by the image processing section; and a recording section for recording the digital image data compressed by the compressing section in a recording medium.

According to the first aspect, digital image data representing an object image is acquired by an image pickup section. Examples of the image pickup section include solid state image pickup devices such as a CCD and a CMOS image sensor.

Here, in this aspect, by the image processing section, first predetermined image processing is performed on digital image data representing a rectangular primary area in the object image, and second predetermined image processing is performed on digital image data representing secondary areas in the object image, i.e., areas other than the primary area in the object image. The second image processing has such an effect that a compression rate for the secondary areas becomes higher than a compression rate for the primary area in the digital image data when the digital image data is compressed.

Then, the digital image data subjected to the image processing by the image processing section is compressed by the compressing section, and the compressed digital image data is recorded in a recording medium by the recording section. It should be noted that, examples of a format of the compression performed by the compressing section include various image compression formats such as the JPEG format, the MPEG format, the MH format, the MR format and the MMR format. Further, examples of the recording medium include semiconductor storage devices such as an EEPROM (Electrically Erasable and Programmable ROM) and a flash memory, and portable recording media such as a SmartMedia(R), an xD-Picture Card, a CompactFlash, an AT Attachment card, a microdrive, a flexible disk, a CD-R (Compact Disk-Recordable), a CD-RW (Compact Disk-ReWritable) and a Magneto-Optical disk or the like.

As described above, according to the first aspect, the digital image data representing the rectangular primary area in the object image represented by the digital image data acquired by the image pickup section is subjected to the first predetermined image processing, and the digital image data representing the secondary areas in the object image is subjected to the second predetermined image processing, which makes an affect such that the compression rate for the secondary areas becomes higher than the compression rate for the primary area in the digital image data when the digital image data is compressed. After this digital image data subjected to the image processing has been compressed, this digital image data is recorded in the recording medium. In this manner, the digital image data representing the secondary areas can be compressed at a compression rate higher than that for the digital image data representing the primary area, and therefore, the amount of the entire digital image data can be effectively reduced while suppressing deterioration of image quality of the object image in the primary area.

A second aspect of the invention is a digital camera including: an image pickup section for acquiring digital image data representing an object image through photographing; a compressing section for performing a first predetermined compression on digital image data representing a rectangular primary area in the object image, and performing a second compression on digital image data representing secondary areas other than the primary area in the object image at a compression rate higher than a compression rate of the first compression; and a recording section for recording the digital image data compressed by the compressing section in a recording medium.

According to this aspect, digital image data representing an object image is acquired by an image pickup section. Examples of the image pickup section include solid state image pickup devices such as a CCD and a CMOS image sensor.

By the compressing section, the first predetermined compression is performed on the digital image data representing the rectangular primary area in the object image, and the second predetermined compression with a compression rate higher than that of the first compression is performed on the digital image data representing the secondary areas, i.e., the areas other than the primary area, in the object image. These compressed digital image data are recorded in the recording medium by the recording section. It should be noted that, examples of a format of the compression performed by the compressing section include various image compression formats such as the JPEG format and the MPEG, which can be performed with variable compression rates. Further, examples of the recording medium include semiconductor storage devices such as an EEPROM and a flash memory, and portable recording media such as a SmartMedia(R), an xD-Picture Card, a CompactFlash, an AT Attachment card, a microdrive, a flexible disk, a CD-R, a CD-RW and a Magneto-Optical disk or the like.

As described above, according to the second aspect, the digital image data representing the rectangular primary area in the object image represented by the digital image data acquired by the image pickup section is subjected to the first predetermined compression, and the digital image data representing the secondary areas in the object image is subjected to the second compression at the compression rate higher than that of the first compression. This compressed digital image data is recorded in the recording medium. Therefore, a data amount of the entire digital image data can be effectively reduced while suppressing deterioration of image quality of the object image in the primary area.

It is preferable that the recording section according to the second aspect separably records the digital image data representing the primary area, which has been subjected to the first compression by the compressing section, and the digital image data representing the secondary areas, which has been subjected to the second compression by the compressing section, in the recording medium. Therefore, one of the digital image data representing the primary area and the digital image data representing the secondary areas can be easily read out from the recording medium selectively, and this facilitates, for example, processing using one or other of the primary or secondary digital image data or processing on one or other of the primary or secondary digital image data.

Further, it is preferable that the recording section according to the second aspect separably records the digital image data representing the primary area, which has been subjected to the first compression by the compressing section, and the digital image data representing the secondary areas, which has been subjected to the second compression by the compressing section, in different areas of the recording medium. Thus, the digital image data can be separably recorded in a simple manner without applying special processing thereto.

A third aspect of the invention is a digital camera including: an image pickup section for acquiring digital image data representing an object image through photographing; a resolution converting section for performing resolution conversion that reduces a resolution of digital image data representing secondary areas other than a rectangular primary area of the object image in the digital image data; a compressing section for performing predetermined compression on the digital image data representing the primary area and the digital image data representing the secondary areas, which has been subjected to resolution conversion by the resolution converting section; and a recording section for recording the digital image data compressed by the compressing section in a recording medium.

According to this aspect, digital image data representing an object image is acquired by an image pickup section. Examples of the image pickup section include solid state image pickup devices such as a CCD and a CMOS image sensor.

In the third aspect, resolution conversion is performed by the resolution converting section to reduce the resolution of the digital image data representing the secondary areas other than the rectangular primary area of the object image in the digital image data.

Then, the compressing section performs predetermined compression on the digital image data representing the primary area and the digital image data representing the secondary areas, which have been subjected to the resolution conversion performed by the resolution converting section. These compressed digital image data are recorded in the recording medium by the recording section. It should be noted that, examples of a format for the compression performed by the compressing section include various image compression formats such as the JPEG format, the MPEG format, the MH format, the MR format and the MMR format. Further, examples of the recording medium include semiconductor storage devices such as EEPROM and flash memory, and portable recording media such as SmartMedia(R), xD-Picture Card, CompactFlash, an AT Attachment card, a microdrive, a flexible disk, a CD-R, a CD-RW and a Magneto-Optical disk or the like.

As described above, according to the third aspect, in the object image represented by digital image data captured by the image pickup section, digital image data representing the secondary areas other than a rectangular primary area is subjected to the resolution conversion for reducing the resolution thereof, and then, the digital image data representing the primary area and the digital image data representing the secondary areas, which have been subjected to the resolution conversion, are subjected to the predetermined compression. Thereafter, these compressed digital image data are recorded in the recording medium. In this manner, a data amount of the compressed digital image data representing the secondary areas can be made lower than that in a case where the compression is performed without reducing the resolution. Therefore, a data amount of the entire digital image data can be effectively reduced while suppressing deterioration of image quality of the object image in the primary area.

It is preferable that the recording section of the third aspect separably records the digital image data representing the primary area, which has been compressed by the compressing section, and the digital image data representing the secondary areas, which has been compressed by compressing section after resolution conversion by the resolution converting section, in the recording medium. Therefore, one or other of the digital image data representing the primary area or the digital image data representing the secondary areas can be easily read out from the recording medium selectively, and this facilitates, for example, processing using one or other of these digital image data or processing on one or other of these digital image data.

It is particularly preferable that the recording section of the third aspect separably records the digital image data representing the primary area, which has been compressed by the compressing section, and the digital image data representing the secondary areas, which has been compressed by the compressing section after resolution conversion by the resolution converting section, in different areas of the recording medium. Thus, the digital image data can be separably recorded in a simple manner without applying special processing thereto.

Further, it is preferable that the third aspect further includes: a decompressing section for decompressing the digital image data recorded in the recording medium; a resolution reducing section for reducing a resolution of the digital image data representing the primary area, which has been decompressed by the decompressing section, such that the resolution of the digital image data representing the primary area becomes the same as the resolution of the digital image data representing the secondary areas, which has been decompressed by the decompressing section; and an image combining section for combining the digital image data representing the secondary areas, which has been decompressed by the decompressing section, with the digital image data representing the primary area, which has been subjected to resolution reduction by the resolution reducing section after being decompressed by the decompressing section, to recover one object image. In this manner, the object image can be recovered by using the digital image data representing the secondary areas, which is compressed after the resolution reduction, and the digital image data representing the primary area, which is compressed without resolution reduction, without generating inconsistency in image resolution between these digital image data.

Alternatively, it is preferable that the third aspect further includes: a decompressing section for decompressing the digital image data recorded in the recording medium; a resolution increasing section for increasing a resolution of the digital image data representing the secondary areas, which has been decompressed by the decompressing section, such that the resolution of the digital image data representing the secondary areas becomes the same as a resolution of the digital image data representing the primary area, which has been decompressed by the decompressing section; and an image combining section for combining the digital image data representing the primary area, which has been decompressed by the decompressing section, with the digital image data representing the secondary areas, which has been subjected to resolution increase by the resolution increasing section after being decompressed by the decompressing section, to recover one object image. Also in this manner, the object image can be recovered by using the digital image data representing the secondary areas, which is compressed after the resolution reduction, and the digital image data representing the primary area, which is compressed without resolution reduction, without generating inconsistency in image resolution between these digital image data.

A fourth aspect of the invention is an image recording method including the steps of: acquiring digital image data representing an object; performing predetermined image processing on the digital image data, the image processing having such an effect that a compression rate for secondary areas other than a rectangular primary area of the digital image data becomes higher than a compression rate for the primary area in the digital image data when the digital image data is compressed; compressing the processed digital image data; and recording the compressed digital image data in a recording medium.

A fifth aspect of the invention is an image recording method including: acquiring digital image data representing an object; performing a first predetermined compression on digital image data of a rectangular primary area in the object image; performing a second compression on digital image data of secondary areas other than the primary area in the object image at a compression rate higher than that of first compression; and recording the compressed digital image data in a recording medium.

It should be noted that, in the first to the fifth aspects, the object image is preferably a rectangular image having an aspect ratio of 4:3, and the rectangular primary area is preferably an area having an aspect ratio of 16:9. Thus, the invention accomplishes making applicable image pickup sections (image pickup devices) that produce object images having an aspect ratio of 4:3, which is the current mainstream, to display devices having a wide-size display area, which is becoming the mainstream of future display devices.

### BRIEF DESCRIPTION OF THE DRAWINGS

Embodiments of the present invention will be described in detail with reference to the following drawings, wherein:

FIG. 1 illustrates external views of a digital camera according to embodiments of the present invention;

FIG. 2 is a block diagram illustrating the main structure of an electric system of the digital camera according to a first embodiment and a second embodiment;

FIG. 3 is a schematic view illustrating a structure of an electronic file (image file) according to the embodiments;

FIG. 4 is a flow chart illustrating a process flow of an image recording program according to the first embodiment;

FIGS. 5A and 5B are schematic views for explaining the process of the image recording program according to the first embodiment;

FIG. 6 is a flow chart illustrating a process flow of an image recording program according to the second embodiment;

FIGS. 7A and 7B are schematic views for explaining the process of the image recording program according to the second embodiment;

FIG. 8 is a block diagram illustrating the main structure of an electric system of a digital camera according to a third embodiment;

FIG. 9 is a flow chart illustrating a process flow of an image recording program according to the third embodiment;

FIGS. 10A and 10B are schematic views for explaining the process of the image recording program according to the third embodiment;

FIG. 11 is a flow chart illustrating a process flow of an image recovering program according to the third embodiment;

FIGS. 12A and 12B are schematic views for explaining the process of the image recovering program according to the third embodiment;

FIG. 13 is a flow chart illustrating a process flow of an alternative image recovering program according to the third embodiment; and

FIGS. 14A and 14B are schematic views for explaining the process of the alternative image recovering program according to the third embodiment.

### DETAILED DESCRIPTION OF THE INVENTION

First Embodiment

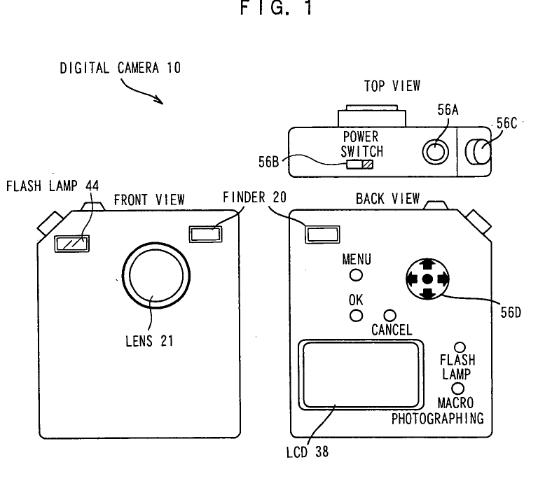

First, with reference to FIG. 1, a configuration of a digital camera 10 according to a first embodiment is described with respect to the appearance thereof.

As shown in FIG. 1, the digital camera 10 includes, at a front surface thereof, a lens 21 for focusing an object image, a flash lamp 44 for emitting light for illuminating an object as necessary for photographing, and a finder 20 used for deciding a picture composition of the object to be photographed. The digital camera 10 further includes, at an upper surface thereof, a release switch (so-called shutter) 56A that is pressed to photograph, a power switch 56B and a mode-switching switch 56C.

It should be noted that, the release switch 56A of the digital camera 10 according to this embodiment is structured so that two-stage pressing operations can be detected including: a state where the release switch 56A is pressed to a half-way position (hereinafter referred to as a “half-pressed state”); and a state where the release switch 56A is pressed beyond the a half-way position to a final position (hereinafter referred to as a “fully pressed state”).

In the digital camera 10, as the release switch 56A is pressed to the half-pressed state, an AE (Automatic Exposure) function is actuated to set exposure conditions (shutter speed, diaphragm conditions), and then, an AF (Auto Focus) function is actuated for focusing control. Subsequently, as the release switch 56A is pressed to the fully pressed state, exposure (photographing) is carried out.

The mode-switching switch 56C is rotated by a user to set the digital camera 10 in one of a photographing mode for photographing, or a replay mode for displaying object images on an LCD 38 (described later).

The digital camera 10 further includes, on a back surface thereof, an eye piece of the finder 20, the liquid crystal display (hereinafter referred to as “LCD”) 38 for displaying photographed object images, a menu screen, and the like, and a cross-shaped cursor switch 56D. The cross-shaped cursor switch 56D includes four arrow keys indicating four directions (upward, downward, rightward and leftward) of movement within a display area of the LCD 38. In the digital camera 10 according to this embodiment, a so-called “wide size” display, which has a display area with the aspect ratio of 16:9, is applied as the LCD 38.

The digital camera 10 further includes, on a back surface thereof, a menu switch that is pressed to display the menu screen on the LCD 38, an “OK” switch that is pressed to set operations made so far, a “CANCEL” switch that is pressed to cancel an operation made just before, a flash lamp switch that is pressed to set emission conditions of the flash lamp 44, and a macro photographing switch that is pressed to carry out macro photographing.

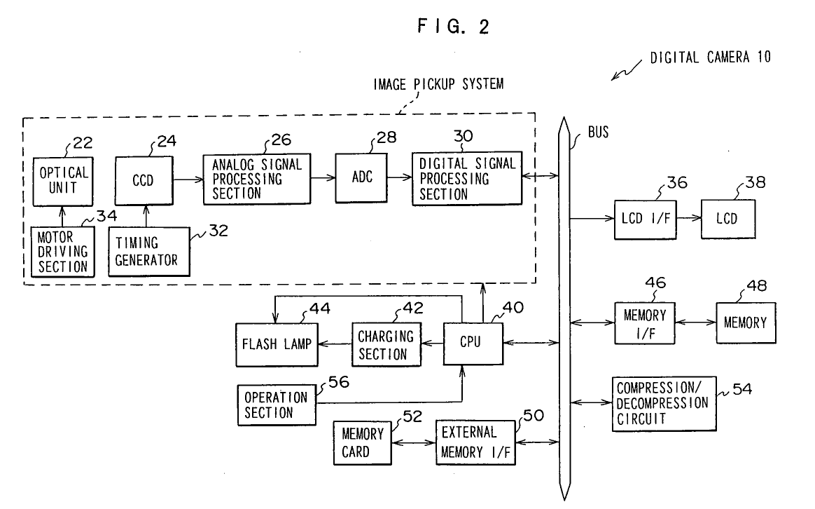

Next, with reference to FIG. 2, the main structure of an electric system of the digital camera 10 according to this embodiment is described.

The digital camera 10 includes an optical unit 22 including the lens 21, a charge-coupled device (hereinafter referred to as a “CCD”) 24 disposed behind the lens 21 along an optical axis, and an analog signal processing section 26 for performing various types of analog signal processing on inputted analog signals.

The digital camera 10 further includes an analog/digital converter (hereinafter referred to as an “ADC”) 28 for converting inputted analog signals into digital data, and a digital signal processing section 30 for performing various types of digital signal processing on inputted digital data.

The digital signal processing section 30 includes a line buffer having a predetermined capacity, and controls storage of the inputted digital data directly in predetermined areas of a memory 48 (described later). In addition, the digital signal processing section 30 according to this embodiment includes a high-cut filter for reducing high spatial frequency components of luminance signals of the digital image data, where the degree of reduction can be set for each of predetermined regions.

An output terminal of the CCD 24 is connected to an input terminal of the analog signal processing section 26, an output terminal of the analog signal processing section 26 is connected to an input terminal of the ADC 28, and an output terminal of the ADC 28 is connected to an input terminal of the digital signal processing section 30. Therefore, an analog signal representing an object image outputted from the CCD 24 is subjected to predetermined analog signal processing performed by the analog signal processing section 26, converted into digital image data by the ADC 28, and then, is inputted to the digital signal processing section 30.

The digital camera 10 further includes: an LCD interface 36 for generating and supplying signals to the LCD 38 for displaying object images, a menu screen, and the like on the LCD 38; a CPU (central processing unit) 40 for controlling overall operation of the digital camera 10; a memory 48 for temporarily storing digital image data acquired through photographing, and the like; and a memory interface 46 for controlling access to the memory 48.

In addition, the digital camera 10 includes an external memory interface 50 for enabling access to a portable memory card 52 from the digital camera 10, and a compression/decompression circuit 54 for compressing and decompressing digital image data.

It should be noted that according to this embodiment, in the digital camera 10 of this embodiment, a VRAM (Video RAM) is used as the memory 48, and a Smart Media(R) is used as the memory card 52.

The digital signal processing section 30, the LCD interface 36, the CPU 40, the memory interface 46, the external memory interface 50, and the compression/decompression circuit 54 are interconnected via a system bus BUS. Therefore, the CPU 40 can control: the operations of the digital signal processing section 30 and the compression/decompression circuit 54; the display of various information on the LCD 38, via the LCD interface 36; and the access to the memory 48 and the memory card 52, via the memory interface 46 and the external memory interface 50 respectively.

The digital camera 10 includes a timing generator 32 for generating and supplying timing signals to the CCD 24 mainly for driving the CCD 24. Drive of the CCD 24 is controlled by the CPU 40 via the timing generator 32.

The digital camera 10 further includes a motor driving section 34. The CPU 40 also controls, via the motor driving section 34, driving of a focus adjusting motor, a zooming motor and a diaphragm driving motor (which are not shown) provided in the optical unit 22.

That is, the lens 21 according to this embodiment includes plural lenses and is formed as a zoom lens that allows alteration of a focal distance (scaling), and is provided with a lens driving mechanism (not shown). The focus adjusting motor, the zooming motor and the diaphragm driving motor are included in the lens driving mechanism, and these motors are respectively driven by driving signals supplied from the motor driving section 34 controlled by the CPU 40.

Further, various switches such as the release switch 56A, the power switch 56B, the mode-switching switch 56C, the cross-shaped cursor switch 56D, and the menu switch (which are collectively referred to as an “operation section 56” in FIG. 2) are connected to the CPU 40, so that the CPU 40 can always be aware of the operation statuses of the operation section 56.

The digital camera 10 further includes a charging section 42, disposed between the flash lamp 44 and the CPU 40, for charging up with electric power for emission of the flash lamp 44 based on control by the CPU 40. The flash lamp 44 is also connected to the CPU 40, so that emission of the flash lamp 44 is controlled by the CPU 40.

It should be noted that the digital camera 10 according to this embodiment is compliant with the Exif (Exchangeable Image File Format) standard, and digital image data acquired through photographing is recorded in the memory card 52 as an electronic file (image file) compliant with the Exif standard.

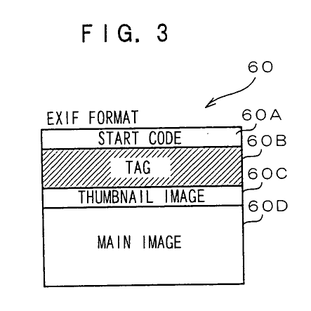

Since the digital camera 10 according to this embodiment is compliant with the Exif standard, an electronic file 60, acquired through photographing and recorded in the memory card 52, includes a start code area 60A, a tag area 60B, a thumbnail image area 60C, and a main image area 60D, as schematically shown in FIG. 3.

Next, overall operation of the digital camera 10 according to this embodiment during photographing is briefly described.

First, the CCD 24 captures an image through the optical unit 22, and sequentially outputs analog signals representing an object image for each of R (red), G (green) and B (blue) components to the analog signal processing section 26. The analog signal processing section 26 performs analog signal processing such as Correlated Double Sampling (CDS) on the analog signals inputted from the CCD 24, and then, sequentially outputs the processed analog signals to the ADC 28.

The ADC 28 converts the analog signals for R, G and B components inputted from the analog signal processing section 26 into 12-bit R, G and B signals (digital image data), and then, sequentially outputs the converted signals (digital image data) to the digital signal processing section 30. The digital signal processing section 30 accumulates the digital image data sequentially inputted from the ADC 28 in the line buffer thereof, and directly stores the digital image data in a predetermined area of the memory 48 for temporary storage.

The digital image data stored in the predetermined area of the memory 48 is read out by the digital signal processing section 30 based on control by the CPU 40, and is subjected to white balance control effected by applying a digital gain according to a predetermined physical quantity, and is also subjected to gamma control and sharpness control, to generate 8-bit digital image data.

Then, the digital signal processing section 30 performs YC signal processing on the generated 8-bit digital image data to generate luminance signals Y and chromatic signals Cr and Cb (hereinafter referred to as “YC signals”), and filters the luminance signals Y with the above-described high-cut filter to reduce the high spatial frequency components of the luminance signals Y by a predetermined degree. Thereafter, the digital signal processing section 30 stores the YC signals in an area other than the predetermined area of the memory 48.

It should be noted that the LCD 38 is formed to be usable as a finder by displaying a motion image (a through image) that is continuously captured by the CCD 24. When the LCD 38 is used as a finder, the generated YC signals are sequentially outputted to the LCD 38 via the LCD interface 36. In this manner, a through image is displayed on the LCD 38.

Here, at a timing when the release switch 56A is pressed by a user to the half-pressed state, as described above, the AE function is actuated to set the exposure conditions, and then, the AF function is actuated for focusing control. Subsequently, at a timing when the release switch 56A is pressed to the fully pressed state, the YC signals stored in the memory 48 at that point in time are compressed by the compression/decompression circuit 54 with a predetermined compression format (the JPEG format in this embodiment), and then recorded in the memory card 52 via the external memory interface 50.

In the digital camera 10 according to this embodiment, the aspect ratio of the captured object image can be selectively set to one of 16:9 and 4:3 by an operation on the menu screen, which is displayed on the LCD 38 when the user presses the menu switch. During the photographing mode, the digital camera 10 can display the object image having the set aspect ratio on the LCD 38 as the through image.

Here, the CCD 24 applied to the digital camera 10 according to this embodiment captures an object image with the aspect ratio of 4:3. In a case where the user has specified the aspect ratio of 16:9 for the object image, when the release switch 56A is pressed to the fully pressed state, digital image data is recorded in the memory card 52 as an electronic file in a state such that an area at a central portion in the top-bottom direction, which corresponds to the aspect ratio of 16:9 (hereinafter referred to as the “wide size area”), in an object image represented by digital image data captured by the CCD 24 is separated from areas other than the wide size area (hereinafter referred to as the “other areas”). It should be noted that, if the user has specified the aspect ratio of 4:3 for the object image, the digital image data is recorded in the memory card 52 as an electronic file without separating the wide size area from the other areas.

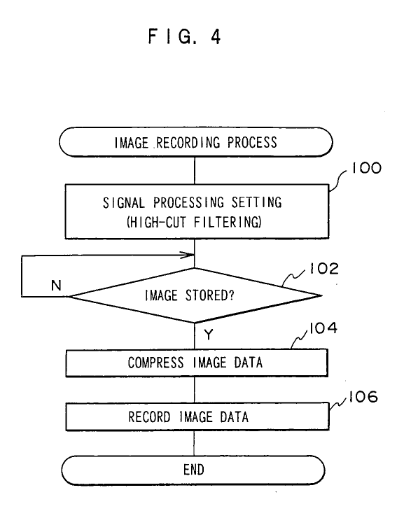

Next, operation of the digital camera 10 for recording an object image in a case where the aspect ratio of 16:9 is set for the object image, a case which is particularly relevant to the invention, is described in detail with reference to FIG. 4. FIG. 4 is a flow chart illustrating a process flow in an image recording program executed by the CPU 40 when the release switch 56A is pressed to the fully pressed state.

In step 100 of FIG. 4, a degree of reduction of high spatial frequency components performed by the high-cut filter included in the digital signal processing section 30 is set such that a degree of reduction for luminance signals Y corresponding to the other areas is higher than a degree of reduction for luminance signals Y corresponding to the wide size area. It should be noted that, here, the degree of reduction for luminance signals Y corresponding to the wide size area is the same as that in a case where the aspect ratio of 4:3 is set for the object image (hereinafter referred to as a “normal degree”).

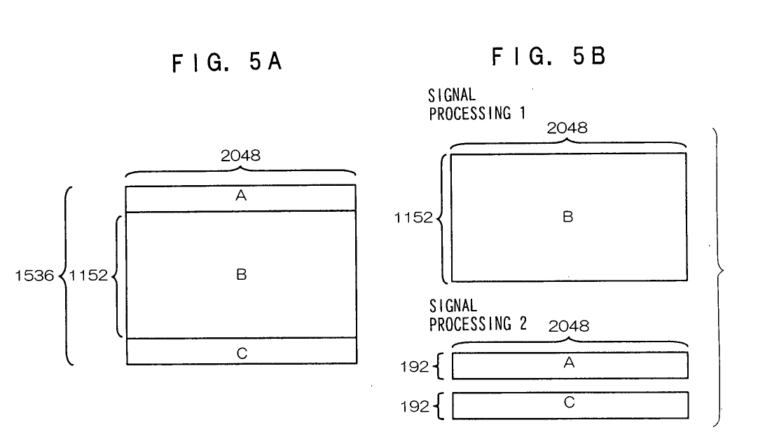

In the following explanation, a case where the digital image data captured by the CCD 24 has a size of 2048×1536 pixels, as shown in FIG. 5A, is described as an example. In this case, as shown in FIG. 5B, through the operation in step 100, an area B having a size of 2048×1152 pixels that is positioned at a central portion in the top-bottom direction, as the wide size area having the aspect ratio of 16:9 , is filtered at the normal degree to reduce high frequency components. The other areas A and C are filtered at the degree higher than the normal degree to reduce high frequency components.

In step 102 next, the digital image data (YC signals), which has the settings made at step 100, waits for storage in the memory 48.

In step 104 next, the compression/decompression circuit 54 is controlled so that the digital image data stored in the memory 48 at this point is compressed in a predetermined compression format (JPEG format). In step 106 next, the digital image data compressed by the compression/decompression circuit 54 is recorded in the memory card 52 as an electronic file of the Exif format, and then, the image recording program ends.

Through this image recording program, high frequency components of the digital image data corresponding to the other areas A and C are reduced more than those of the digital image data corresponding to the wide size area B. Therefore, a rate of compression performed by the compression/decompression circuit 54 on the other areas A, C can be made higher than that on the digital image data corresponding to the wide size area B. Consequently, a data amount of the entire digital image data can be effectively reduced without deteriorating image quality of the wide size area.

As described in detail above, according to this embodiment, in an object image represented by digital image data captured by an image pickup section (the CCD 24 in this embodiment), digital image data representing a rectangular primary area (the wide size area in this embodiment) is subjected to predetermined image processing (filtering by the high-cut filter in this embodiment), and digital image data representing the secondary areas (herein the other areas) is subjected to image processing with an effect that, when the digital image data is compressed, a compression rate for the digital image data representing the secondary areas becomes higher than a compression rate for the digital image data representing the primary area subjected to the predetermined image processing. The digital image data subjected to these types of image processing is compressed, and then, the digital image data is recorded in a recording medium (the memory card 52 in this embodiment). Thus, the digital image data representing the secondary areas can be compressed at a compression rate higher than that for the digital image data representing the primary area. Therefore, a data amount of the entire digital image data can be effectively reduced while suppressing deterioration of image quality of the object image in the primary area.

It should be noted that, although the compression rates of the wide size area and the other areas are differentiated by altering the degree of reduction of high frequency components by the high-cut filter in this embodiment, this is not intended to limit the invention. For example, the compression rates of the wide size area and the other areas can be differentiated by whether or not the high-cut filter is used. Also in this case, the same effect as this embodiment can be obtained.

Further, although the filtering by the high-cut filter is applied as the image processing of the invention in this embodiment, this is not intended to limit the invention. Any image processing can be applied as long as a higher compression rate for the other areas than that for the wide size area can be obtained as a result.

Second Embodiment

In a second embodiment, an exemplary embodiment of a case where the image of other areas is compressed at a compression rate higher than that for the image of the wide size area is described. The structure of a digital camera according to the second embodiment is the same as that of the digital camera 10 according to the first embodiment (see FIGS. 1 and 2), except that the rate of compression performed by the compression/decompression circuit 54 on the digital image data (YC signals) can be set for each of predetermined areas, and therefore, explanation thereof is omitted here.

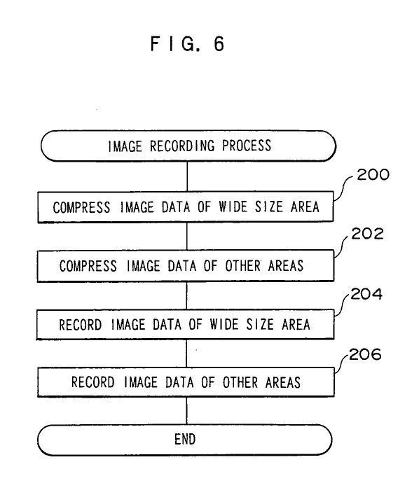

In the following explanation, operation of the digital camera 10 for recording an object image in a case where the aspect ratio of 16:9 is set for the object image, a case which is particularly relevant to the invention, is described in detail with reference to FIG. 6. FIG. 6 is a flow chart illustrating a process flow in an image recording program executed by the CPU 40 when the release switch 56A is pressed to the fully pressed state.

In step 200 of FIG. 6, the compression/decompression circuit 54 is controlled so that data corresponding to the wide size area of the digital image data stored in the memory 48 at this point in time is compressed with a predetermined compression format (JPEG format) at a predetermined compression rate. In step 202 next, the compression/decompression circuit 54 is controlled so that data corresponding to the other areas of the digital image data stored in the memory 48 at this point in time is compressed with the predetermined compression format at a compression rate higher than the predetermined compression rate for the wide size area. It should be noted that, here, the compression rate for the data corresponding to the wide size area is the same as that in a case where the aspect ratio of 4:3 is set for the object image (hereinafter referred to as a “normal compression rate”).

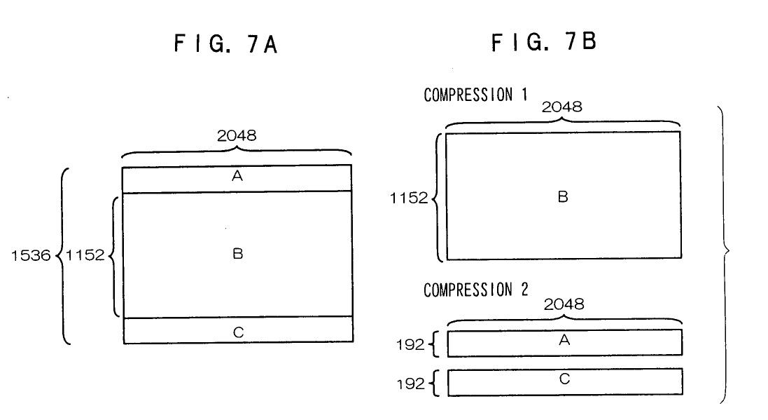

In a case where the digital image data captured by the CCD 24 has a size, for example, of 2048×1536 pixels, as shown in FIG. 7A, an area B having a size of 2048×1152 pixels that is positioned at a central portion in the top-bottom direction, as shown in FIG. 7B, is compressed at the normal compression rate as the wide size area having the aspect ratio of 16:9 through the above-described process. The other areas A and C are compressed at the rate higher than the normal compression rate.

In step 204 next, the digital image data corresponding to the wide size area, which has been compressed in step 200, is recorded in the main image area 60D as an electronic file of the Exif format. In step 206 next, the digital image data corresponding to the other areas, which has been compressed in step 202, is recorded in the tag area 60B of the electronic file, and then, the image recording program ends.

Through this image recording program, the rate of compression performed by the compression/decompression circuit 54 on the other areas A and C can be made higher than that for the digital image data corresponding to the wide size area B. Consequently, a data amount of the entire digital image data can be effectively reduced without deteriorating image quality of the wide size area.

As described in detail above, according to this embodiment, in an object image represented by digital image data captured by an image pickup section (the CCD 24 in this embodiment), digital image data representing a rectangular primary area (the wide size area in this embodiment) is subjected to predetermined compression, and digital image data representing the secondary areas (herein the other areas) is subjected to compression at a rate higher than that of the predetermined compression for the primary area, and the compressed digital image data are recorded in the recording medium (the memory card 52 in this embodiment). Therefore, a data amount of the entire digital image data can be effectively reduced while suppressing deterioration of image quality of the object image in the primary area.

Further, according to this embodiment, the compressed digital image data representing the primary area and the compressed digital image data representing the secondary areas are separably recorded in the recording medium. Therefore, one or other of the digital image data representing the primary area and the digital image data representing the secondary areas can be easily read out from the recording medium selectively, and this facilitates, for example, processing using one or other of the digital image data or processing on one or other of the digital image data.

In addition, according to this embodiment, the compressed digital image data representing the primary area and the compressed digital image data representing the secondary areas are recorded in different areas of the recording medium so that they are separable. In this manner, the digital image data can be separably recorded in a simple manner without applying special processing thereto.

Third Embodiment

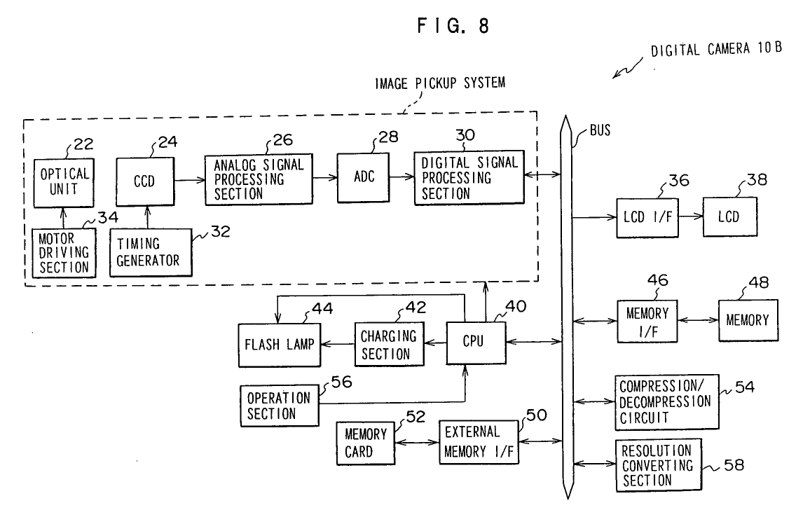

In a third embodiment, an exemplary embodiment of a case where an image resolution of the other areas is made lower than that of the wide size area is described. A configuration of a digital camera with respect to appearance thereof according to the third embodiment is the same as that of the digital camera 10 according to the first embodiment (see FIG. 1), and therefore, explanation thereof is omitted here. First, with reference to FIG. 8, the main structure of an electric system of a digital camera 10B according to the third embodiment is described. Components in FIG. 8 that are the same as those in FIG. 2 are assigned with the same reference numeral, and explanation thereof is omitted.

As shown in FIG. 8, a difference between the digital camera 10B according to this embodiment and the digital camera 10 according to the first embodiment lies in a newly added resolution converting section 58. The resolution converting section 58 converts a resolution of digital image data, and a resulting resolution of the conversion can be set for each of predetermined areas.

The resolution converting section 58 is connected to the system bus BUS, so that the CPU 40 can control operation of the resolution converting section 58.

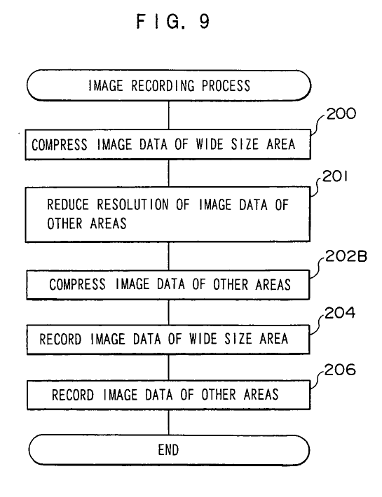

Next, operation of the digital camera 10B for recording an object image in a case where the aspect ratio of 16:9 is set for the object image, a case which is particularly relevant to the invention, is described in detail with reference to FIG. 9. FIG. 9 is a flow chart illustrating a process flow in an image recording program executed by the CPU 40 of the digital camera 10B when the release switch 56A is pressed to the fully pressed state. Steps of FIG. 9 that perform the same operation as those of FIG. 6 are assigned with the same step numbers as in FIG. 6, and explanation thereof is omitted.

In step 201 of FIG. 9, the resolution converting section 58 is controlled so that a resolution of data corresponding to the other areas of the digital image data stored in the memory 48 at this point is reduced to a predetermined resolution (in this embodiment, the resolution of the image represented by the data is reduced to one half of the original resolution in two directions, i.e., the left-right direction and the top-bottom direction). In the resolution converting section 58 according to this embodiment, the resolution conversion is effected by thinning out one pixel for every adjacent two pixels in two directions, i.e., the left-right direction and the top-bottom direction, of the image represented by the data corresponding to the other areas.

In step 202B next, the compression/decompression circuit 54 is controlled so that the data corresponding to other areas with the resolution thereof reduced in step 201 is compressed in the predetermined compression format (JPEG format) at the normal compression rate.

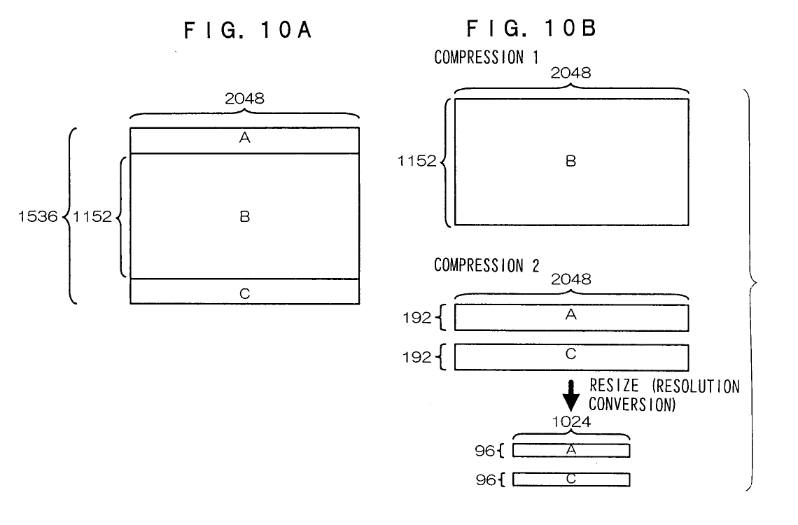

In a case where the digital image data captured by the CCD 24 has a size, for example, of 2048×1536 pixels, as shown in FIG. 10A, an area B having a size of 2048×1152 pixels that is positioned at a central portion in the top-bottom direction as shown in FIG. 10B, as the wide size area having the aspect ratio of 16:9, is compressed at the normal compression rate through the above operations. The other areas A and C are compressed at the normal compression rate after their resolution has been reduced and they have been resized.

Through this image recording program, a data amount after the compression performed by the compression/decompression circuit 54 on the other areas A and C can be made lower than that in a case where the data is compressed without reducing the resolution. Consequently, a data amount of the entire digital image data can be effectively reduced without deteriorating image quality of the wide size area.

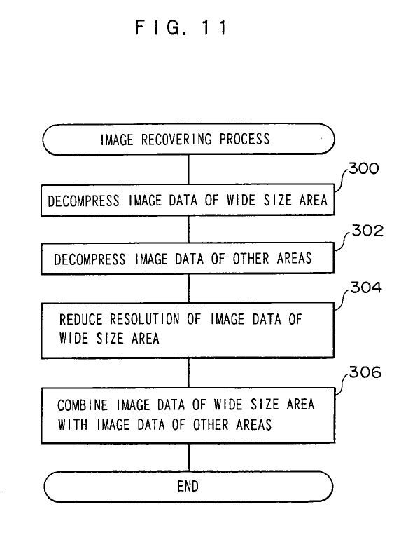

Next, with reference to FIG. 11, operation of the digital camera 10 for recovering the digital image data that is recorded with the aspect ratio of the object image set to 16:9, in a case where a replay mode or the like is set by the user, is described in detail. FIG. 11 is a flow chart illustrating a process flow of an image recovering program executed by the CPU 40 for recovering the digital image data. Here, a case is explained where an electronic file containing the digital image data to be recovered (hereinafter referred to as a “file to be processed”) is specified by the user.

In step 300 of FIG. 11, the compression/decompression circuit 54 is controlled so that the digital image data corresponding to the wide size area recorded in the main image area 60D of the file to be processed, which is recorded in the memory card 52 in the Exif format, is decompressed in a format according to the compression format (JPEG format). In step 302 next, the compression/decompression circuit 54 is controlled so that the digital image data corresponding to the other areas, recorded in the tag area 60B of the file to be processed, is decompressed in the format according to the compression format.

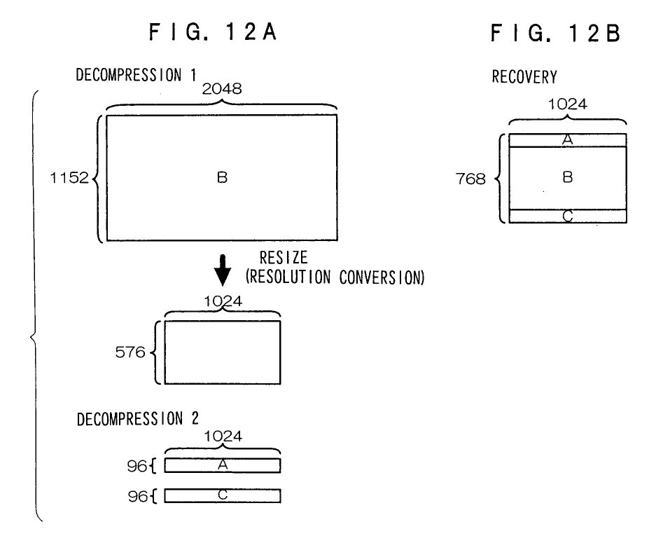

In a case where the digital image data corresponding to the wide size area B recorded in the file to be processed has a size of 2048×1152 pixels, and the digital image data corresponding to other areas A and C with the reduced resolution recorded in the file to be processed have a size of 1024×96 pixels, as shown in FIG. 10B as an example, the digital image data is reproduced through the above-described operations, so that each area has the same number of pixels as that at the time of recording, as shown in FIG. 12A.

In step 304 next, the resolution converting section 58 is controlled so that the resolution of the digital image data corresponding to the wide size area, which has been decompressed in step 300, is reduced to the same resolution as that of the other areas. In the resolution converting section 58 according to this embodiment, the resolution reduction is effected by thinning out one pixel for every adjacent two pixels in two directions, i.e., the left-right direction and the top-bottom direction, of the image represented by the data corresponding to the wide size area. Thus, as shown in FIG. 12A as an example, the digital image data corresponding to the wide size area B is converted into 1024×576 pixels.

In step 306 next, the digital image data of the wide size area having the resolution thereof reduced in step 304 and the digital image data of the other areas decompressed in step 302 are combined together, and then, the image recovering program ends.

Through the operation in step 306, as shown in FIG. 12B as an example, digital image data representing a state where the other area A is combined with the wide size area B at the upper end portion of the wide size area B and the other area C is combined with the wide size area B at the lower end portion of the wide size area B can be obtained.

As described in detail above, according to this embodiment, in an object image represented by digital image data captured by an image pickup section (the CCD 24 in this embodiment), digital image data representing secondary areas other than a rectangular primary area (the wide size area in this embodiment) is subjected to resolution conversion for reducing a resolution thereof. The digital image data representing the primary area and the digital image data representing the secondary areas, which have been subjected to the resolution conversion, are subjected to predetermined compression, and then, these compressed digital image data are recorded in a recording medium (the memory card 52 in this embodiment). In this manner, a data amount of the compressed digital image data representing the secondary areas can be made lower than that in a case where the compression is performed without reducing the resolution. Therefore, a data amount of the entire digital image data can be effectively reduced while suppressing deterioration of image quality of the object image in the primary area.

Further, according to this embodiment, the compressed digital image data representing the primary area and the digital image data representing the secondary areas, which have been compressed after the resolution conversion, are separably recorded in the recording medium. Therefore, one of the digital image data representing the primary area and the digital image data representing the secondary areas can be easily read out from the recording medium selectively, and this facilitates, for example, processing using one or other of the digital image data or processing on one or other of the digital image data.

Moreover, according to this embodiment, the compressed digital image data representing the primary area and the digital image data representing the secondary areas, which have been compressed after the resolution conversion, are recorded in different areas of the recording medium so that they are separable. In this manner, the digital image data can be separably recorded in a simple manner without applying special processing thereto.

In addition, according to this embodiment, for recovering the recorded object image, the digital image data recorded in the recording medium is decompressed, and the resolution of the decompressed digital image data representing the primary area is reduced to the same resolution as that of the decompressed digital image data representing the secondary areas. Then, the decompressed digital image data representing the secondary areas and the decompressed digital image data representing the primary area having the resolution thereof reduced after the decompression are combined together to recover one object image. In this manner, the object image can be recovered by using the digital image data representing the secondary areas, which is compressed after the resolution reduction, and the digital image data representing the primary area, which is compressed without resolution reduction, without generating inconsistency in pixel size between these digital image data.

It should be noted that, although, in the third embodiment, the resolution of the wide size area is reduced to make the resolutions of the wide size area and the other areas the same in the image recovering program (see FIG. 11), this is not intended to limit the invention. For example, the resolution of the other areas may be increased to make the resolutions of the wide size area and the other areas the same.

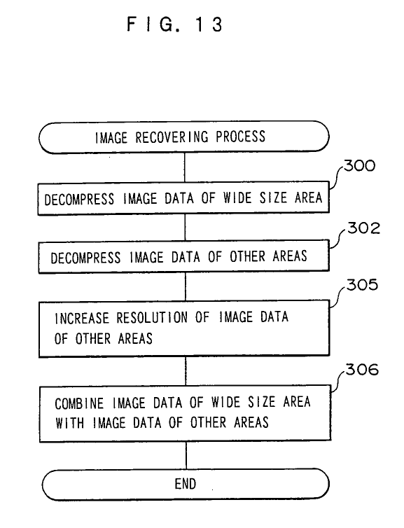

FIG. 13 shows an example of the image recovering program of this case. Steps of FIG. 13 that perform the same operation as those of FIG. 11 are assigned with the same step numbers as in FIG. 11.

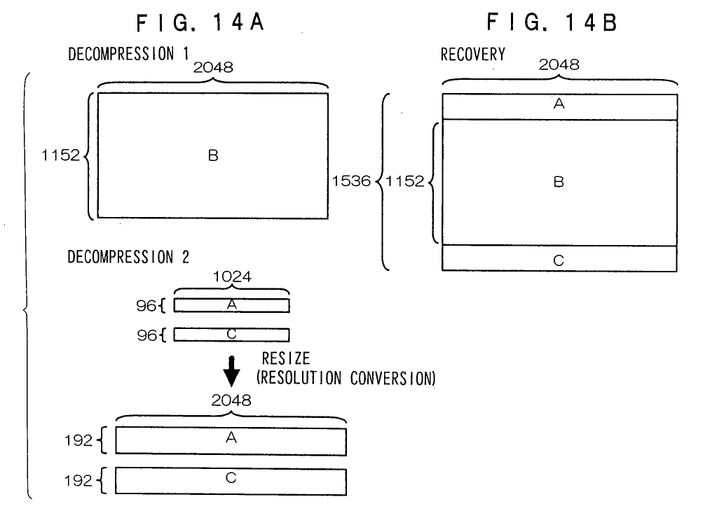

In step 305 of the image recovering program shown in FIG. 13, the resolution converting section 58 is controlled so that the resolution of the digital image data corresponding to the other areas, which has been decompressed in step 302, is increased to the same resolution as that of the wide size area. In this case, in the resolution converting section 58, the resolution increase is effected by generating, using interpolation, one pixel between every adjacent two pixels in two directions, i.e., the left-right direction and the top-bottom direction, of the image represented by the data corresponding to the other areas. In this manner, as shown in FIG. 14A as an example, the digital image data corresponding to the other areas A and C are converted from 1024×96 pixels to 2048×192 pixels.

These digital image data are combined together in step 306 next, as shown in FIG. 14B, and consequently, the digital image data of 2048×1536 pixels can be recovered.

In this case, the resolution of the digital image data corresponding to the wide size area is not reduced. Therefore, compared with the third embodiment, the image quality of the wide size area in the recovered digital image data can be improved.

Further, although the digital image data corresponding to the other areas is recorded in the tag area of the electronic file of the Exif format in the second and the third embodiments, this is not intended to limit the invention. For example, the digital image data corresponding to the other areas may be recorded as an electronic file separate from the electronic file for the digital image data corresponding to the wide size area. In this case, it is necessary to include information for specifying the associated electronic files in at least one of the electronic file corresponding to the wide size area and the electronic file corresponding to the other areas, so that the associated electronic files can be specified using the information. Also in this case, the same effects can be obtained as in the second and the third embodiments.

Furthermore, although the aspect ratio of 16:9 is applied to the primary area of the invention in the above-described embodiments, this is not intended to limit the invention. It is apparent that other aspect ratios are also applicable. Also in this case, the same effects can be obtained as in the above-described embodiments.

The invention can also be accomplished as an image recording method for recording digital image data with an amount thereof effectively reduced. Process flows of the various processing programs (see FIGS. 4, 6, 9, 11 and 13) described in the above embodiments are examples of the method. Obviously, these processes can be appropriately changed without departing from the scope and spirit of the invention.

In addition, the structures of the digital camera 10 described in the embodiments (see FIGS. 1, 2, and 8) are also examples, and obviously they can be appropriately changed without departing from the scope and spirit of the invention.

1. A digital camera comprising:
an image pickup section for acquiring digital image data representing an object image through photographing;
an image processing section for performing a first predetermined image processing on digital image data representing a rectangular primary area in the object image, and performing a second predetermined image processing on digital image data representing secondary areas other than the primary area in the object image, the second image processing having such an effect that a compression rate for the secondary areas becomes higher than a compression rate for the primary area in the digital image data when the digital image data is compressed;
a compressing section for compressing the digital image data processed by the image processing section; and
a recording section for recording the digital image data compressed by the compressing section in a recording medium.

2. The digital camera as claimed in claim 1, wherein
the first image processing reduces high spatial frequency components of the digital image data representing the primary area,
the second image processing reduces high spatial frequency components of the digital image data representing the secondary areas, and
a degree of the reduction in the second image processing is higher than a degree of the reduction in the first image processing.

3. The digital camera as claimed in claim 1, wherein the object image is a rectangular image having an aspect ratio of 4:3, and the rectangular primary area is an area having an aspect ratio of 16:9.

4. A digital camera comprising:
an image pickup section for acquiring digital image data representing an object image through photographing;
a compressing section for performing a first predetermined compression on digital image data representing a rectangular primary area in the object image, and performing a second compression on digital image data representing secondary areas other than the primary area in the object image at a compression rate higher than a compression rate of the first compression; and
a recording section for recording the digital image data compressed by the compressing section in a recording medium.

5. The digital camera as claimed in claim 4, wherein the recording section separably records the digital image data representing the primary area, which has been subjected to the first compression by the compressing section, and the digital image data representing the secondary areas, which has been subjected to the second compression by the compressing section, in the recording medium.

6. The digital camera as claimed in claim 5, wherein the recording section separably records the digital image data representing the primary area, which has been subjected to the first compression by the compressing section, and the digital image data representing the secondary areas, which has been subjected to the second compression by the compressing section, in different areas of the recording medium.

7. The digital camera as claimed in claim 4, wherein the object image is a rectangular image having an aspect ratio of 4:3, and the rectangular primary area is an area having an aspect ratio of 16:9.

8. A digital camera comprising:
an image pickup section for acquiring digital image data representing an object image through photographing;
a resolution converting section for performing resolution conversion that reduces a resolution of digital image data representing secondary areas other than a rectangular primary area of the object image in the digital image data;
a compressing section for performing predetermined compression on the digital image data representing the primary area and the digital image data representing the secondary areas, which has been subjected to resolution conversion by the resolution converting section; and
a recording section for recording the digital image data compressed by the compressing section in a recording medium.

9. The digital camera as claimed in claim 8, wherein the recording section separably records the digital image data representing the primary area, which has been compressed by the compressing section, and the digital image data representing the secondary areas, which has been compressed by the compressing section after resolution conversion by the resolution converting section, in the recording medium.

10. The digital camera as claimed in claim 9, wherein the recording section separably records the digital image data representing the primary area, which has been compressed by the compressing section, and the digital image data representing the secondary areas, which has been compressed by the compressing section after resolution conversion by the resolution converting section, in different areas of the recording medium.

11. The digital camera as claimed in claim 8, further comprising:
a decompressing section for decompressing the digital image data recorded in the recording medium;
a resolution reducing section for reducing a resolution of the digital image data representing the primary area, which has been decompressed by the decompressing section, such that the resolution of the digital image data representing the primary area becomes the same as the resolution of the digital image data representing the secondary areas, which has been decompressed by the decompressing section; and
an image combining section for combining the digital image data representing the secondary areas, which has been decompressed by the decompressing section, with the digital image data representing the primary area, which has been subjected to resolution reduction by the resolution reducing section after being decompressed by the decompressing section, to recover one object image.

12. The digital camera as claimed in claim 8, further comprising:
a decompressing section for decompressing the digital image data recorded in the recording medium;
a resolution increasing section for increasing a resolution of the digital image data representing the secondary areas, which has been decompressed by the decompressing section, such that the resolution of the digital image data representing the secondary areas becomes the same as a resolution of the digital image data representing the primary area, which has been decompressed by the decompressing section; and
an image combining section for combining the digital image data representing the primary area, which has been decompressed by the decompressing section, with the digital image data representing the secondary areas, which has been subjected to resolution increase by the resolution increasing section after being decompressed by the decompressing section, to recover one object image.

13. The digital camera as claimed in claim 8, wherein the object image is a rectangular image having an aspect ratio of 4:3, and the rectangular primary area is an area having an aspect ratio of 16:9.

14. An image recording method comprising:
acquiring digital image data representing an object;
performing predetermined image processing on the digital image data, the image processing having such an effect that a compression rate for secondary areas, other than a rectangular primary area of the digital image data, becomes higher than a compression rate for the primary area in the digital image data when the digital image data is compressed;
compressing the processed digital image data; and
recording the compressed digital image data in a recording medium.

15. The image recording method as claimed in claim 14, wherein the image processing comprises:
first image processing for reducing high spatial frequency components of the digital image data of the primary area; and
second image processing for reducing high spatial frequency components of the digital image data of the secondary areas,
wherein a degree of the reduction in the second image processing is higher than a degree of the reduction in the first image processing.

16. The image recording method as claimed in claim 14, wherein the image processing is resolution conversion for reducing a resolution of the digital image data of the secondary areas.

17. The image recording method as claimed in claim 16, wherein the recording separably records the compressed digital image data of the primary area and the resolution-converted and compressed digital image data of the secondary areas in the recording medium.

18. The image recording method as claimed in claim 17, wherein the recording separably records the compressed digital image data of the primary area and the resolution-converted and compressed digital image data of the secondary areas in different areas of the recording medium.

19. The image recording method as claimed in claim 16, further comprising:
decompressing the recorded digital image data;
reducing a resolution of the decompressed digital image data of the primary area so that the resolution of the decompressed digital image data of the primary area becomes the same as the resolution of the decompressed digital image data of the secondary areas; and
combining the decompressed digital image data of the secondary areas with the decompressed and resolution-reduced digital image data of the primary area to recover one object image.

20. The image recording method as claimed in claim 16, further comprising:
decompressing the recorded digital image data;
increasing the resolution of the decompressed digital image data of the secondary areas so that the resolution of the decompressed digital image data of the secondary areas becomes the same as a resolution of the decompressed digital image data of the primary area; and
combining the decompressed digital image data of the primary area with the decompressed and resolution-increased digital image data of the secondary areas to recover one object image.

21. The image recording method as claimed in claim 14, wherein the object image is a rectangular image having an aspect ratio of 4:3, and the rectangular primary area is an area having an aspect ratio of 16:9.

22. An image recording method comprising:
acquiring digital image data representing an object;
performing a first predetermined compression on digital image data of a rectangular primary area in the object image;
performing a second compression on digital image data of secondary areas other than the primary area in the object image at a compression rate higher than that of first compression; and
recording the compressed digital image data in a recording medium.

23. The image recording method as claimed in claim 22, wherein the recording separably records the digital image data of the primary area subjected to the first compression and the digital image data of the secondary areas subjected to the second compression in the recording medium.

24. The image recording method as claimed in claim 23, wherein the recording separably records the digital image data of the primary area subjected to the first compression and the digital image data of the secondary areas subjected to the second compression in different areas of the recording medium.

25. The image recording method as claimed in claim 22, wherein the object image is a rectangular image having an aspect ratio of 4:3, and the rectangular primary area is an area having an aspect ratio of 16:9.
